(19) United States
(12) Patent Application Publication
(10) Pub. No.: US 2015/0264629 A1
(43) Pub. Date: Sep. 17, 2015

(54) USER LOCATION BASED NETWORK REGISTRATION

(71) Applicant: NOKIA SOLUTIONS AND NETWORKS OY, Espoo (FI)

(72) Inventor: Juha Antero Rasanen, Espoo (FI)

(21) Appl. No.: 14/439,721

(22) PCT Filed: Oct. 30, 2012
(86) PCT No.: PCT/EP2012/071465

§ 371 Date: Apr. 30, 2015

(51) Int. Cl. H04W 48/04; H04W 60/04; H04L 29/08; H04W 4/02

(52) U.S. Cl. CPC H04W 48/04; H04W 4/02; H04W 60/04; H04L 67/306; H04W 88/02

(57) ABSTRACT

There are provided measures for user location based network registration. Such measures exemplarily comprise receiving a registration request comprising at least identity information indicative of a communication endpoint, transmitting a communication endpoint information request comprising at least said identity information, receiving a communication endpoint information response comprising at least information related to a location of said communication endpoint, and handling said registration request based on said information related to said location of said communication endpoint.

### FIELD

The present invention relates to user location based network registration. More specifically, the present invention exemplarily relates to measures (including methods, apparatuses and computer program products) for realizing user location based network registration.

### BACKGROUND

The present specification generally relates to allowance or disallowance of registration of a terminal, i.e. a user equipment (UE), to a network. In particular, the present specification relates to permission control of registration of a terminal to certain services or a certain subsystem of the network.

In current discussions of the 3^{rd} Generation Partnership Project (3GPP) Group regarding the Release 12 of the Long Term Evolution Advanced (LTE-A) standard, the need for a permission control of registration to the Internet Protocol (IP) multimedia subsystem (IMS) arose. Summarized requirements to such permission control are, for fixed line, that the IP multimedia core network (IM CN) subsystem supports control of UE registration based on network information which is related to the location of the UE (e.g. IP address, digital subscriber line access multiplexer (DSLAM) information, etc). Further, the registration control shall be based on subscription information which indicates whether registration control applies and to which location registrations are to be restricted. According to further establishment of the 3GPP in this regard, the control of the IMS registration based on the network location of the UE (such as IP address, DSLAM information etc) is to be specified and an architectural solution for the above mentioned requirements is to be provided.

According to the current 3GPP policy and/or charging control (PCC) specifications the user location information can be made available to the policy and charging rules function (PCRF) upon an IP connectivity access network (IP-CAN) session establishment (i.e. after the UE attaches to the network) and user location updates can be provided to the PCRF whenever they take place. The PCRF can send the user location information and updates to a proxy call server control function (P-CSCF), if requested or subscribed to by the P-CSCF.

However, reliable user location information is not available, when a UE registers to an IMS. A permanent/static IP address or address range could be used at least in theory and through relevant configuration or interpretation as user's location information. In this regard it is to be noted that IP address of a fixed broadband access user/UE may be either static or dynamic, and address ranges used by the fixed network operator may be changed by the operator in course of time. Consequently, an IP address or address range based location identification may not be reliable or usable.

A further option (and straightforward solution) to achieve the location information of the user/UE is adding (by the UE) an additional location parameter or parameters to the registration message.

However, in this case the problems arise that the location indication can not be regarded as reliable, if this location indication originates from the UE.

Further, such a solution would cause changes to the basic IMS registration messages and would have an impact on several IMS entities in the network.

In addition, registration messages would have to be exchanged through the whole chain of IMS elements up to the home subscriber server (HSS), even if the registration request is eventually rejected.

Hence, there is a need to provide for user location based network registration. In particular, there is a need to solve (some of) the above stated problems.

### SUMMARY

Various exemplary embodiments of the present invention aim at addressing at least part of the above issues and/or problems and drawbacks.

Various aspects of exemplary embodiments of the present invention are set out in the appended claims.

According to an exemplary aspect of the present invention, there is provided a method comprising receiving a registration request comprising at least identity information indicative of a communication endpoint, transmitting a communication endpoint information request comprising at least said identity information, receiving a communication endpoint information response comprising at least information related to a location of said communication endpoint, and handling said registration request based on said information related to said location of said communication endpoint.

According to an exemplary aspect of the present invention, there is provided a method comprising receiving a communication endpoint information request comprising at least identity information indicative of a communication endpoint, obtaining information related to a location of said communication endpoint based on said identity information, and transmitting a communication endpoint information response comprising at least said information related to said location of said communication endpoint.

According to an exemplary aspect of the present invention, there is provided a method comprising receiving a registration allowance query comprising at least identity information indicative of a communication endpoint, and transmitting a registration allowance response comprising at least information related to registration allowance of said communication endpoint.

According to an exemplary aspect of the present invention, there is provided an apparatus comprising a connection controller configured to receive a registration request comprising at least identity information indicative of a communication endpoint, to transmit a communication endpoint information request comprising at least said identity information, and to receive a communication endpoint information response comprising at least information related to a location of said communication endpoint, and a control module configured to handle said registration request based on said information related to said location of said communication endpoint.

According to an exemplary aspect of the present invention, there is provided an apparatus comprising a connection controller configured to receive a communication endpoint information request comprising at least identity information indicative of a communication endpoint, and a control module configured to obtain information related to a location of said communication endpoint based on said identity information, wherein said connection controller is further configured to transmit a communication endpoint information response comprising at least said information related to said location of said communication endpoint.

According to an exemplary aspect of the present invention, there is provided an apparatus comprising a connection controller configured to receive a registration allowance query comprising at least identity information indicative of a communication endpoint, and to transmit a registration allowance response comprising at least information related to registration allowance of said communication endpoint.

According to an exemplary aspect of the present invention, there is provided a computer program product comprising computer-executable computer program code which, when the program is run on a computer (e.g. a computer of an apparatus according to any one of the aforementioned apparatus-related exemplary aspects of the present invention), is configured to cause the computer to carry out the method according to any one of the aforementioned method-related exemplary aspects of the present invention.

Such computer program product may comprise (or be embodied) a (tangible) computer-readable (storage) medium or the like on which the computer-executable computer program code is stored, and/or the program may be directly loadable into an internal memory of the computer or a processor thereof.

Any one of the above aspects enables an efficient permission control of registration of a terminal to certain services or a certain subsystem of the network to thereby solve at least part of the problems and drawbacks identified in relation to the prior art.

By way of exemplary embodiments of the present invention, there is provided user location based network registration. More specifically, by way of exemplary embodiments of the present invention, there are provided measures and mechanisms for realizing user location based network registration.

Thus, improvement is achieved by methods, apparatuses and computer program products enabling/realizing user location based network registration.

### BRIEF DESCRIPTION OF THE DRAWINGS

In the following, the present invention will be described in greater detail by way of non-limiting examples with reference to the accompanying drawings, in which

FIG. 1 is a block diagram illustrating an apparatus according to exemplary embodiments of the present invention,

FIG. 2 is a block diagram illustrating an apparatus according to exemplary embodiments of the present invention,

FIG. 3 is a block diagram illustrating an apparatus according to exemplary embodiments of the present invention,

FIG. 4 is a schematic diagram of a procedure according to exemplary embodiments of the present invention,

FIG. 5 is a schematic diagram of a procedure according to exemplary embodiments of the present invention,

FIG. 6 is a schematic diagram of a procedure according to exemplary embodiments of the present invention,

FIG. 7 shows a schematic diagram of signaling sequences according to exemplary embodiments of the present invention, and

FIG. 8 is a block diagram alternatively illustrating apparatuses according to exemplary embodiments of the present invention.

### DETAILED DESCRIPTION OF DRAWINGS AND EMBODIMENTS OF THE PRESENT INVENTION

The present invention is described herein with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary network configurations and deployments. Namely, the present invention and its embodiments are mainly described in relation to 3GPP specifications being used as non-limiting examples for certain exemplary network configurations and deployments. In particular, permission control of registration to IMS is used as a non-limiting example for the applicability of thus described exemplary embodiments. As such, the description of exemplary embodiments given herein specifically refers to terminology which is directly related thereto. Such terminology is only used in the context of the presented non-limiting examples, and does naturally not limit the invention in any way. Rather, any other communication or communication related system deployment, etc. may also be utilized as long as compliant with the features described herein.

Hereinafter, various embodiments and implementations of the present invention and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

According to exemplary embodiments of the present invention, in general terms, there are provided measures and mechanisms for (enabling/realizing) user location based network registration.

According to exemplary embodiments of the present invention, a P-CSCF requests the user/UE location and/or IMS registration related information from the PCRF after receiving an IMS registration request from the UE, but before proceeding with the registration procedure.

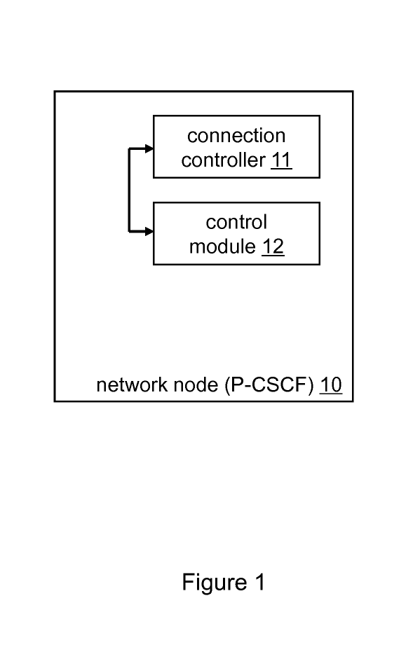

FIG. 1 is a block diagram illustrating an apparatus according to exemplary embodiments of the present invention.

As shown in FIG. 1, according to exemplary embodiments of the present invention, the apparatus is a network node (P-CSCF) 10 comprising a connection controller 11 and a control module 12. The connection controller 11 receives a registration request comprising at least identity information indicative of a communication endpoint. The connection controller 11 further transmits a communication endpoint information request comprising at least said identity information, and receives a communication endpoint information response comprising at least information related to a location of said communication endpoint. The control module 12 handles said registration request based on said information related to said location of said communication endpoint.

In other words, when the P-CSCF receives an IMS registration request message from the UE, the P-CSCF sends a request message to the PCRF to get the user/UE location information (which the PCRF has received from the gateway (GW) during the IP-CAN session establishment or modification/update) and/or to get an indication on whether the user/UE is allowed to register to IMS from the current location of the user/UE.

The PCRF provides the P-CSCF with the requested user/UE location information (in the response message to the P-CSCF).

The P-CSCF uses the parameters of the response received from the PCRF to decide on how to proceed with the registration.

According to further exemplary embodiments of the present invention, said information related to said location of said communication endpoint is a network location of said communication endpoint. Further, said control module 12 adds said network location to said registration request. In addition, said connection controller 12 forwards said registration request.

In other words, if the P-CSCF gets only the location information from the PCRF, the P-CSCF puts the location information in the registration message sent (further) towards the IMS network elements (i.e. interrogating call server control function (I-CSCF), HSS and serving call server control function (S-CSCF)). The decision on whether the registration is allowed or not allowed from the current location is then made by a procedure involving HSS and S-CSCF.

According to further exemplary embodiments of the present invention, said information related to said location of said communication endpoint is a registration permission based on said location of said communication endpoint. If said registration permission is granted, the connection controller 11 forwards said registration request. If said registration permission is denied, the connection controller 12 transmits a registration rejection.

That is, if the P-CSCF gets a “registration allowed/not allowed” indication from the PCRF, the P-CSCF uses this to decide on how to proceed with the registration. If the registration is allowed, the P-CSCF sends the registration message as such/according to current specifications further towards the IMS network elements (i.e. I-CSCF, HSS and S-CSCF). If the registration is not allowed, the P-CSCF sends a rejection to the UE, and no messages need to be sent towards the IMS core entities.

According to still further exemplary embodiments of the present invention, the connection controller 11 further receives a registration acknowledgement. Further, the connection controller 11 forwards said registration acknowledgement.

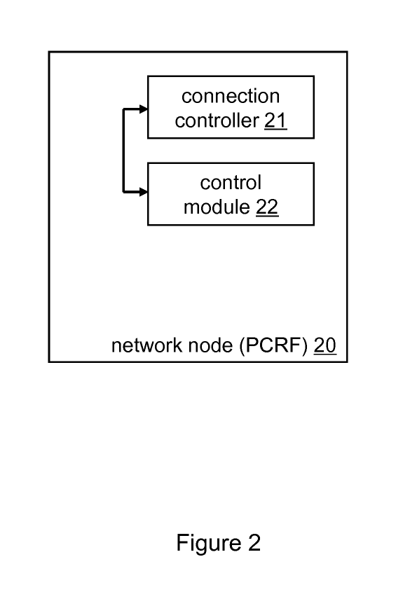

FIG. 2 is a block diagram illustrating an apparatus according to exemplary embodiments of the present invention.

As shown in FIG. 2, according to exemplary embodiments of the present invention, the apparatus is a network node (PCRF) 20 comprising a connection controller 21 and a control module 22. The connection controller 21 receives a communication endpoint information request comprising at least identity information indicative of a communication endpoint. Further, the control module 22 obtains information related to a location of said communication endpoint based on said identity information. In addition, the connection controller 21 transmits a communication endpoint information response comprising at least said information related to the location of said communication endpoint.

According to exemplary embodiments of the present invention the apparatus may thus have got the location received from the GW during the IP-CAN session establishment or modification/update.

Accordingly, the PCRF provides the P-CSCF with the requested user/UE location information (in the response message to the P-CSCF).

According to further exemplary embodiments of the present invention, the control module 22 further achieves a network location of said communication endpoint as said information related to the location of said communication endpoint.

In other words, the PCRF makes sure that up-to-date location information is available by subscribing to the location information from the network element capable to provide the information (e.g. a GW or a policy control entity), when an IP-CAN session establishment is made to an IMS access point (APN). Alternatively, the PCRF may request the user/UE location information from the network element capable to provide the information (e.g. a GW or a policy control entity), when receiving the request from the P-CSCF.

According to further exemplary embodiments of the present invention, the connection controller 21 further transmits a registration allowance query comprising at least said identity information, and receives a registration allowance response comprising at least information related to registration allowance of said communication endpoint. Further, the control module 22 determines a registration permission based on said information related to registration allowance of said communication endpoint as said information related to said location of said communication endpoint.

That is, according to exemplary embodiments of the present invention, the PCRF firstly makes an inquiry to a subscription register (subscription profile repository (SPR)/user data repository (UDR)) in order to find out (from the subscription profile of the user/UE) whether the user/UE is allowed to register to IMS from the current location of the user/UE.

According to exemplary embodiments of the present invention, the information related to registration allowance of said communication endpoint is a user profile of said communication endpoint indicative of registration allowance dependent on a network location. The control module 22 achieves a network location of said communication endpoint. The control module 22 further deduces the registration permission from said user profile and said network location of said communication endpoint.

According to exemplary embodiments of the present invention, the control module 22 further achieves a network location of said communication endpoint. In doing so, the registration allowance query further comprises said network location of said communication endpoint, and the information related to registration allowance of said communication endpoint is an allowance state based on said network location of said communication endpoint. The control module 22 reproduces said allowance state as said registration permission.

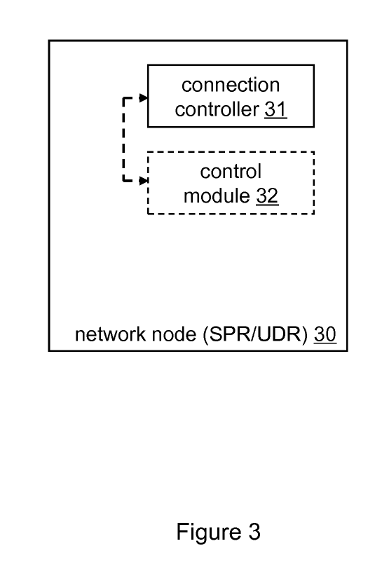

FIG. 3 is a block diagram illustrating an apparatus according to exemplary embodiments of the present invention.

As shown in FIG. 3, according to exemplary embodiments of the present invention, the apparatus is a network node (SPR/UDR) 30 comprising a connection controller 31. The connection controller receives a registration allowance query comprising at least identity information indicative of a communication endpoint. The connection controller further transmits a registration allowance response comprising at least information related to registration allowance of said communication endpoint.

According to further embodiments of the present invention, the information related to registration allowance of said communication endpoint is a user profile of said communication endpoint indicative of registration allowance dependent on a network location of said communication endpoint.

According to still further embodiments of the present invention, the registration allowance query further comprises a network location of said communication endpoint. The apparatus further comprises a control module 32 that obtains an allowance state based on said network location of said communication endpoint as said information related to registration allowance of said communication endpoint.

In other words, the PCRF may first make an inquiry to the subscription register (SPR/UDR) in order to find out (from the subscription profile of the user/UE) whether the user/UE is allowed to register to IMS from the current location of the user/UE, and the subscription register answers appropriately.

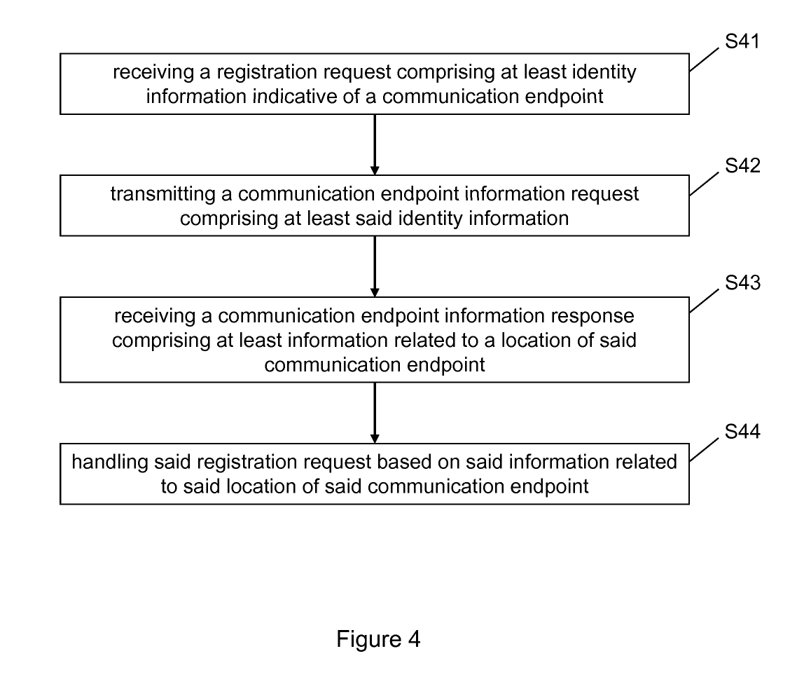

FIG. 4 is a schematic diagram of a procedure according to exemplary embodiments of the present invention.

As shown in FIG. 4, a procedure according to exemplary embodiments of the present invention comprises an operation of receiving a registration request comprising at least identity information indicative of an communication endpoint, an operation of transmitting a communication endpoint information request comprising at least said identity information, an operation of receiving a communication endpoint information response comprising at least information related to a location of said communication endpoint, and an operation of handling said registration request based on said information related to said location of said communication endpoint.

According to a variation of the procedure shown in FIG. 4, the information related to said location of said communication endpoint is a network location of said communication endpoint, and exemplary additional operations and exemplary details of the handling operation are given, which are inherently independent from each other as such. According to such variation, an exemplary method according to exemplary embodiments of the present invention may comprise an operation of adding said network location to said registration request.

Such exemplary handling operation according to exemplary embodiments of the present invention may comprise an operation of forwarding said registration request.

According to a variation of the procedure shown in FIG. 4, the information related to said location of said communication endpoint is a registration permission based on said location of said communication endpoint, and exemplary details of the handling operation are given, which are inherently independent from each other as such.

Such exemplary handling operation according to exemplary embodiments of the present invention may comprise an operation of forwarding said registration request, if said registration permission is granted, and transmitting a registration rejection, if said registration permission is denied.

According to a variation of the procedure shown in FIG. 4, exemplary additional operations are given, which are inherently independent from each other as such. According to such variation, an exemplary method according to exemplary embodiments of the present invention may comprise an operation of receiving a registration acknowledgement, and an operation of forwarding said registration acknowledgement.

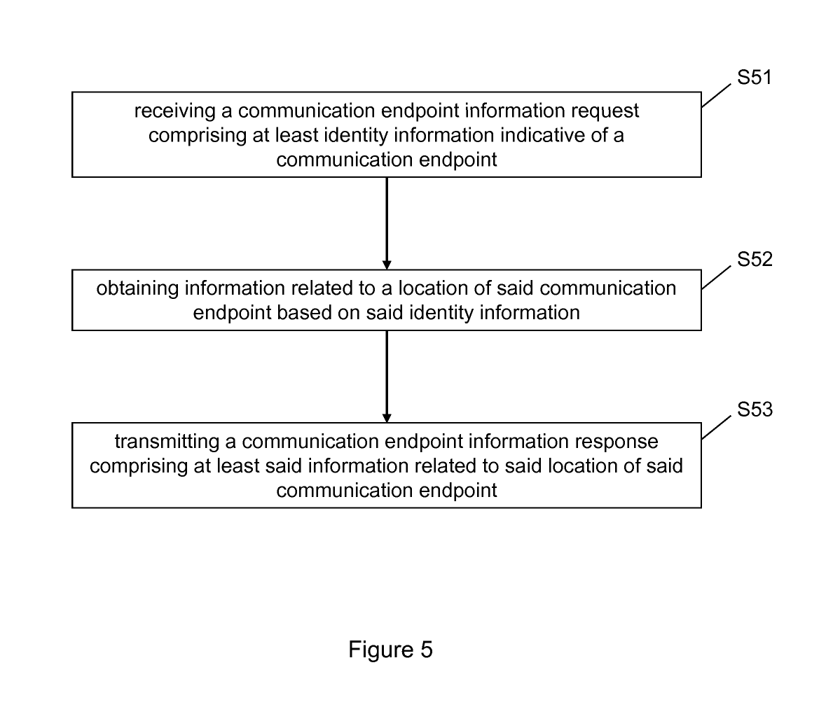

FIG. 5 is a schematic diagram of a procedure according to exemplary embodiments of the present invention.

As shown in FIG. 5, a procedure according to exemplary embodiments of the present invention comprises an operation of receiving a communication endpoint information request comprising at least identity information indicative of a communication endpoint, an operation of obtaining information related to a location of said communication endpoint based on said identity information, and an operation of transmitting a communication endpoint information response comprising at least said information related to said location of said communication endpoint.

According to a variation of the procedure shown in FIG. 5, exemplary details of the obtaining operation are given, which are inherently independent from each other as such.

Such exemplary obtaining operation according to exemplary embodiments of the present invention may comprise an operation of achieving a network location of said communication endpoint as said information related to said location of said communication endpoint.

According to a variation of the procedure shown in FIG. 5, exemplary details of the obtaining operation are given, which are inherently independent from each other as such.

Such exemplary obtaining operation according to exemplary embodiments of the present invention may comprise an operation of transmitting a registration allowance query comprising at least said identity information, an operation of receiving a registration allowance response comprising at least information related to registration allowance of said communication endpoint, and an operation of determining a registration permission based on said information related to registration allowance of said communication endpoint as said information related to said location of said communication endpoint.

According to a variation of the procedure shown in FIG. 5, the information related to registration allowance of said communication endpoint is a user profile of said communication endpoint indicative of registration allowance dependent on a network location, and exemplary additional operations and exemplary details of the determining operation are given, which are inherently independent from each other as such. According to such variation, an exemplary method according to exemplary embodiments of the present invention may comprise an operation of achieving a network location of said communication endpoint.

Such exemplary determining operation according to exemplary embodiments of the present invention may comprise an operation of deducing said registration permission from said user profile and said network location of said communication endpoint.

According to a variation of the procedure shown in FIG. 5, exemplary additional operations and exemplary details of the determining operation are given, which are inherently independent from each other as such. According to such variation, an exemplary method according to exemplary embodiments of the present invention may comprise an operation of achieving a network location of said communication endpoint. In doing so, the registration allowance query further comprises said network location of said communication endpoint, and the information related to registration allowance of said communication endpoint is an allowance state based on said network location of said communication endpoint.

An exemplary determining operation according to exemplary embodiments of the present invention may comprise an operation of reproducing said allowance state as said registration permission.

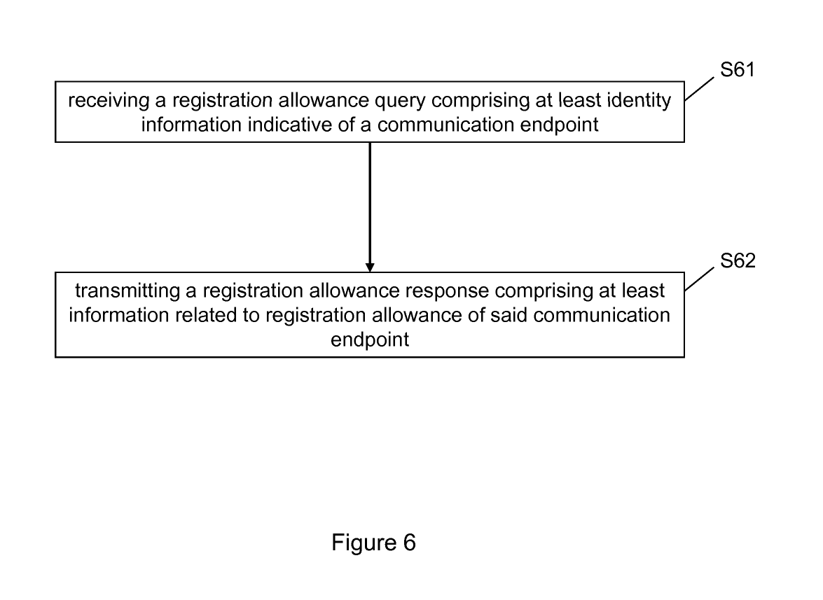

FIG. 6 is a schematic diagram of a procedure according to exemplary embodiments of the present invention.

As shown in FIG. 6, a procedure according to exemplary embodiments of the present invention comprises an operation of receiving a registration allowance query comprising at least identity information indicative of a communication endpoint, and an operation of transmitting a registration allowance response comprising at least information related to registration allowance of said communication endpoint.

According to further exemplary embodiments of the present invention, the information related to registration allowance of said communication endpoint is a user profile of said communication endpoint indicative of registration allowance dependent on a network location of said communication endpoint.

According to a variation of the procedure shown in FIG. 6, the registration allowance query further comprises a network location of said communication endpoint, and exemplary additional operations are given, which are inherently independent from each other as such. According to such variation, an exemplary method according to exemplary embodiments of the present invention may comprise an operation of obtaining an allowance state based on said network location of said communication endpoint as said information related to registration allowance of said communication endpoint.

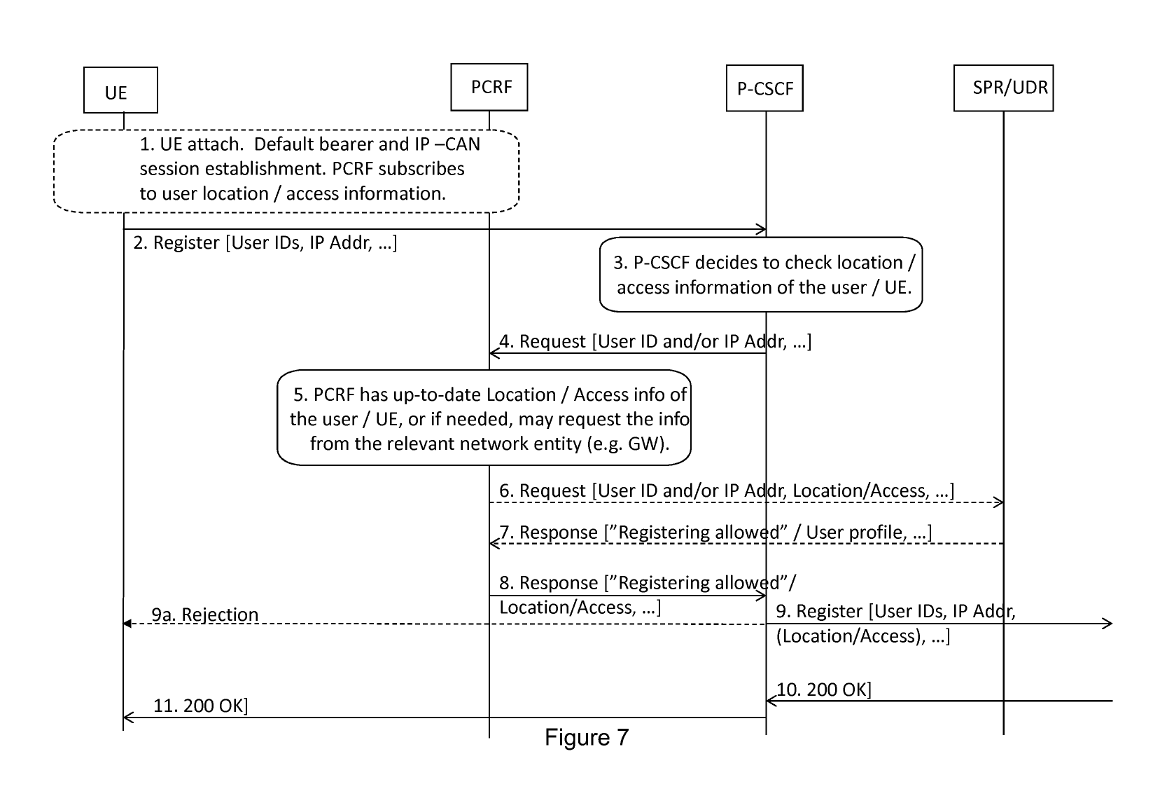

FIG. 7 shows a schematic diagram of signaling sequences according to exemplary embodiments of the present invention.

In FIG. 7 possible signaling sequences according to the exemplary complex scenario of an IMS register request handling as described in connection with FIGS. 1 to 6 are illustrated. Namely, FIG. 7 describes detailed operation referring the above mentioned network elements as an excerpt of more detailed IMS registration scenarios.

The steps displayed in FIG. 7 are described in the following according to exemplary embodiments of the present invention.

According to (preferable) exemplary embodiments of the present invention, an SPR/UDR enquiry is performed and no impact on current IMS registering signalling is effected:

1. UE attaches to the network. A default bearer and an IP-CAN session are established. The PCRF may subscribe to the user/UE location/access information from a/the network element capable to provide the information (e.g. a GW or a policy control entity). The PCRF may make the subscription only when noticing that the IP-CAN session establishment is made to an IMS access point.

2. UE sends an IMS register message to P-CSCF.

3. P-CSCF decides to check the location/access information of the user/UE.

4. P-CSCF sends a relevant request (communication endpoint information request) to PCRF, identifying the user/UE with a user ID or an IP address or both.

5. PCRF may have up-to-date location/access information of the user/UE as per the subscription made in above mentioned step 1, or if needed, PCRF may request the info from the relevant network element.

6. PCRF makes an inquiry to the subscription register (SPR/UDR) in order to find out (from the subscription profile of the user/UE) whether the user/UE is allowed to register to IMS from the current location of the user/UE. PCRF may send the user/UE location parameter in the message to get a specific location related response, or the PCRF may just identify the user/UE to get the subscription profile (which then contains also the registration control information).

7. SPR/UDR sends a response which contains at least the registration control information (“registering allowed/not allowed”), but may contain further parameters like e.g. the whole user profile.

8. PCRF responds to the request from P-CSCF (above mentioned step 4). The response includes an indication on whether the registration to IMS from the current user/UE location is allowed or not allowed.

9. If the registering is allowed, P-CSCF sends the register message further towards the IMS core network elements. The message may be fully compliant with the current specifications, i.e. no new parameters are needed. If the registering is not allowed, steps 9-11 of FIG. 7 do not take place, but instead of them P-CSCF sends a rejection to UE (not shown in FIG. 7).

10. P-CSCF receives a “200 OK” (registration acknowledgement) response message from the IMS core.

11. P-CSCF sends the “200 OK” response message further to UE.

According to these exemplary embodiments of the present invention, the crucial elements are P-CSCF, PCRF and SPR/UDR. Existing (according to existing specifications) request/response messages can be re-used between these entities, but a new parameter/new parameters are added (e.g. above mentioned step 4).

According to further exemplary embodiments of the present invention, no SPR/UDR enquiry is needed and an impact on current IMS registering signalling is effected:

1. UE attaches to the network. A default bearer and an IP-CAN session are established. The PCRF may subscribe to the user/UE location/access information from a/the network element capable to provide the information (e.g. a GW or a policy control entity). The PCRF may make the subscription only when noticing that the IP-CAN session establishment is made to an IMS access point.

2. UE sends an IMS register message to P-CSCF.

3. P-CSCF decides to check the location/access information of the user/UE.

4. P-CSCF sends a relevant request (communication endpoint information request) to PCRF, identifying the user/UE with a user ID or an IP address or both.

5. PCRF may have up-to-date location/access information of the user/UE as per the subscription made in the above mentioned step 1, or if needed, PCRF may request the info from the relevant network element.

6. and 7. According to these exemplary embodiments of the present invention, steps 6 and 7 as illustrated in Figure are not performed.

8. PCRF responds to the request from P-CSCF (above mentioned step 4). The response includes the user/UE location related parameter(s).

9. P-CSCF puts the user/UE location related parameter(s) in the register message and sends the message further towards the IMS core network elements, leaving it up to the IMS core (HSS, S-CSCF) to decide whether the registration to IMS from the current user/UE location is allowed or not allowed.

10. P-CSCF receives a “200 OK” response message from the IMS core.

11. P-CSCF sends the “200 OK” response message further to UE.

If the SPR/UDR enquiry is not used according to these exemplary embodiments, a new location related parameter/new location related parameters are to be added to existing IMS registration messages (see above mentioned step 9).

According to exemplary embodiments of the present invention, the number of exchanged messages between P-CSCF and PCRF does not necessarily have to increase, because the messages 4, 6, 7 and 8 could (optionally) replace the similar message exchange (according to the current specifications) where the P-CSCF subscribes to notifications of the status of the application function (AF) signalling transmission path, i.e. those two procedures could possibly be merged.

Use cases of the present invention are for example but not exclusively operators offering IMS services at lower prices by limiting the access to given fixed broadband accesses and corporate customers limiting IMS access to given fixed locations/accesses to save costs.

The above-described procedures and functions may be implemented by respective functional elements, processors, or the like, as described below.

In the foregoing exemplary description of the network entity, only the units that are relevant for understanding the principles of the invention have been described using functional blocks. The network entity may comprise further units that are necessary for its respective operation. However, a description of these units is omitted in this specification. The arrangement of the functional blocks of the devices is not to be construed to limit the invention, and the functions may be performed by one block or further split into sub-blocks.

When in the foregoing description it is stated that the apparatus, i.e. network node (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “unit configured to” is to be construed to be equivalent to an expression such as “means for”).

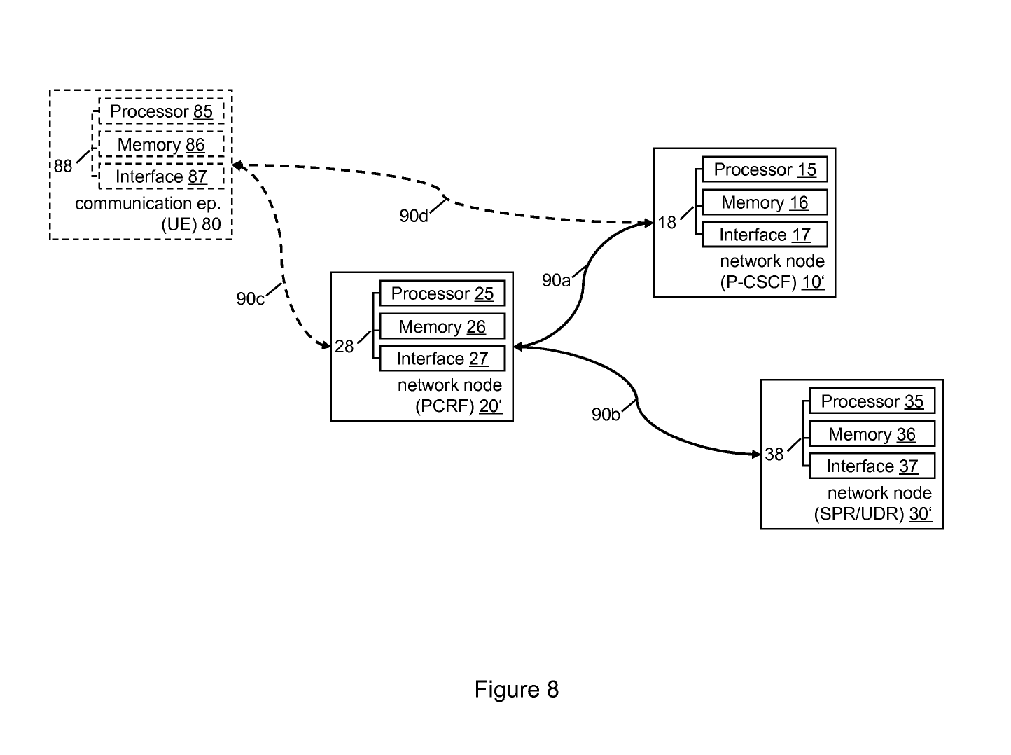

In FIG. 8, an alternative illustration of apparatuses according to exemplary embodiments of the present invention is depicted. As indicated in FIG. 8, according to exemplary embodiments of the present invention, the apparatus (network node, P-CSCF) 10′ (corresponding to the network node 10) comprises a processor 15, a memory 16 and an interface 17, which are connected by a bus 18 or the like. Further, according to exemplary embodiments of the present invention, the apparatus (network node, PCRF) 20′ (corresponding to the network node 20) comprises a processor 25, a memory 26 and an interface 27, which are connected by a bus 28 or the like. Further, according to exemplary embodiments of the present invention, the apparatus (network node, SPR/UDR) 30′ (corresponding to the network node 30) comprises a processor 35, a memory 36 and an interface 37, which are connected by a bus 38 or the like. For the sake of completeness, a terminal (communication endpoint, UE) 80 is depicted in addition in FIG. 8. The apparatuses may be connected via links 90a, 90b, 90c and 90d, respectively.

The processor 15/25/35 and/or the interface 17/27/37 may also include a modem or the like to facilitate communication over a (hardwire or wireless) link, respectively. The interface 17/27/37 may include a suitable transceiver coupled to one or more antennas or communication means for (hardwire or wireless) communications with the linked or connected device(s), respectively. The interface 17/27/37 is generally configured to communicate with at least one other apparatus, i.e. the interface thereof.

The memory 16/26/36 may store respective programs assumed to include program instructions or computer program code that, when executed by the respective processor, enables the respective electronic device or apparatus to operate in accordance with the exemplary embodiments of the present invention.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is to be construed to be equivalent to an expression such as “means for xxx-ing”).

According to exemplary embodiments of the present invention, an apparatus representing the network node 10 comprises at least one processor 15, at least one memory 16 including computer program code, and at least one interface 17 configured for communication with at least another apparatus. The processor (i.e. the at least one processor 15, with the at least one memory 16 and the computer program code) is configured to perform receiving a registration request comprising at least identity information indicative of an communication endpoint (thus the apparatus comprising corresponding means for receiving), to perform transmitting a communication endpoint information request comprising at least said identity information (thus the apparatus comprising corresponding means for transmitting), to perform receiving a communication endpoint information response comprising at least information related to a location of said communication endpoint, and to perform handling said registration request based on said information related to said location of said communication endpoint (thus the apparatus comprising corresponding means for handling).

According to exemplary embodiments of the present invention, an apparatus representing the network node 20 comprises at least one processor 25, at least one memory 26 including computer program code, and at least one interface 27 configured for communication with at least another apparatus. The processor (i.e. the at least one processor 25, with the at least one memory 26 and the computer program code) is configured to perform receiving a communication endpoint information request comprising at least identity information indicative of a communication endpoint (thus the apparatus comprising corresponding means for receiving), to perform obtaining information related to a location of said communication endpoint based on said identity information (thus the apparatus comprising corresponding means for transmitting), and to perform transmitting a communication endpoint information response comprising at least said information related to said location of said communication endpoint (thus the apparatus comprising corresponding means for transmitting).

According to exemplary embodiments of the present invention, an apparatus representing the network node 30 comprises at least one processor 35, at least one memory 36 including computer program code, and at least one interface 37 configured for communication with at least another apparatus. The processor (i.e. the at least one processor 35, with the at least one memory 36 and the computer program code) is configured to perform receiving a registration allowance query comprising at least identity information indicative of a communication endpoint (thus the apparatus comprising corresponding means for receiving), and to perform transmitting a registration allowance response comprising at least information related to registration allowance of said communication endpoint (thus the apparatus comprising corresponding means for transmitting).

For further details regarding the operability/functionality of the individual apparatuses, reference is made to the above description in connection with any one of FIGS. 1 to 6, respectively.

For the purpose of the present invention as described herein above, it should be noted that
method steps likely to be implemented as software code portions and being run using a processor at a network server or network entity (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined network entity or network register, or any one of their respective units/means) can be implemented as individual devices, units or means, but this does not exclude that they are implemented in a distributed fashion throughout the system, as long as the functionality of the device, unit or means is preserved;
an apparatus like the user equipment and the network entity/network register may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In view of the above, there are provided measures for user location based network registration. Such measures exemplarily comprise receiving a registration request comprising at least identity information indicative of a communication endpoint, transmitting a communication endpoint information request comprising at least said identity information, receiving a communication endpoint information response comprising at least information related to a location of said communication endpoint, and handling said registration request based on said information related to said location of said communication endpoint.

Even though the invention is described above with reference to the examples according to the accompanying drawings, it is to be understood that the invention is not restricted thereto. Rather, it is apparent to those skilled in the art that the present invention can be modified in many ways without departing from the scope of the inventive idea as disclosed herein.

### LIST OF ACRONYMS AND ABBREVIATIONS

3GPP 3^{rd} Generation Partnership Project

AF application function

APN access point name

DSLAM digital subscriber line access multiplexer

GW gateway

HSS home subscriber server

I-CSCF interrogating call server control function

IP Internet Protocol

IP-CAN IP connectivity access network

IM CN IP multimedia core network

IMS IP multimedia subsystem

LTE-A Long Term Evolution Advanced

PCC policy and/or charging control

PCRF policy and charging rules function

P-CSCF proxy call server control function

S-CSCF serving call server control function

SPR subscription profile repository

UDR user data repository

UE user equipment

1. A method comprising
receiving a registration request comprising at least identity information indicative of a communication endpoint,
transmitting a communication endpoint information request comprising at least said identity information,
receiving a communication endpoint information response comprising at least information related to a location of said communication endpoint, and
handling said registration request based on said information related to said location of said communication endpoint.

2. The method according to claim 1, wherein
said information related to said location of said communication endpoint is a network location of said communication endpoint, and said method further comprises
adding said network location to said registration request, and
in relation to said handling, said method further comprises forwarding said registration request.

3. The method according to claim 1, wherein
said information related to said location of said communication endpoint is a registration permission based on said location of said communication endpoint, and
if said registration permission is granted, in relation to said handling said method further comprises
forwarding said registration request, and
if said registration permission is denied, in relation to said handling said method further comprises
transmitting a registration rejection.

4. (canceled)

5. A method comprising
receiving a communication endpoint information request comprising at least identity information indicative of a communication endpoint,
obtaining information related to a location of said communication endpoint based on said identity information, and
transmitting a communication endpoint information response comprising at least said information related to said location of said communication endpoint.

6. (canceled)

7. The method according to claim 5, wherein
in relation to said obtaining, said method further comprises transmitting a registration allowance query comprising at least said identity information,
receiving a registration allowance response comprising at least information related to registration allowance of said communication endpoint, and
determining a registration permission based on said information related to registration allowance of said communication endpoint as said information related to said location of said communication endpoint.

8. (canceled)

9. The method according to claim 7, further comprising
achieving a network location of said communication endpoint, wherein
said registration allowance query further comprises said network location of said communication endpoint,
said information related to registration allowance of said communication endpoint is an allowance state based on said network location of said communication endpoint, and
in relation to said determining, said method further comprises
reproducing said allowance state as said registration permission.

10.-12. (canceled)

13. An apparatus comprising
a connection controller configured to
receive a registration request comprising at least identity information indicative of a communication endpoint,
to transmit a communication endpoint information request comprising at least said identity information, and to
receive a communication endpoint information response comprising at least information related to a location of said communication endpoint, and
a control module configured to handle said registration request based on said information related to said location of said communication endpoint.

14. The apparatus according to claim 13, wherein
said information related to said location of said communication endpoint is a network location of said communication endpoint, and said control module is further configured to
add said network location to said registration request, and
said connection controller is further configured to forward said registration request.

15. (canceled)

16. (canceled)

17. n apparatus comprising
a connection controller configured to receive a communication endpoint information request comprising at least identity information indicative of a communication endpoint, and
a control module configured to obtain information related to a location of said communication endpoint based on said identity information, wherein
said connection controller is further configured to transmit a communication endpoint information response comprising at least said information related to said location of said communication endpoint.

18. The apparatus according to claim 17, wherein
said control module is further configured to achieve a network location of said communication endpoint as said information related to said location of said communication endpoint.

19. The apparatus according to claim 18, wherein
said connection controller is further configured to
transmit a registration allowance query comprising at least said identity information, and to
receive a registration allowance response comprising at least information related to registration allowance of said communication endpoint, and
said control module is further configured to determine a registration permission based on said information related to registration allowance of said communication endpoint as said information related to said location of said communication endpoint.

20. The apparatus according to claim 19, wherein
said information related to registration allowance of said communication endpoint is a user profile of said communication endpoint indicative of registration allowance dependent on a network location, and
said control module is further configured to
achieve a network location of said communication endpoint, and to
deduce said registration permission from said user profile and said network location of said communication endpoint.

21. The apparatus according to claim 19, wherein
said control module is further configured to achieve a network location of said communication endpoint, wherein
said registration allowance query further comprises said network location of said communication endpoint, and
said information related to registration allowance of said communication endpoint is an allowance state based on said network location of said communication endpoint, and
said control module is further configured to reproduce said allowance state as said registration permission.

22. An apparatus comprising
a connection controller configured to
receive a registration allowance query comprising at least identity information indicative of a communication endpoint, and to
transmit a registration allowance response comprising at least information related to registration allowance of said communication endpoint.

23. The apparatus according to claim 22, wherein
said information related to registration allowance of said communication endpoint is a user profile of said communication endpoint indicative of registration allowance dependent on a network location of said communication endpoint.

24.-26. (canceled)
